(19) United States
(12) Patent Application Publication
(10) Pub. No.: US 2026/0077676 A1
(43) Pub. Date: Mar. 19, 2026

(54) Method for Monitoring an Energy Storage Device

(71) Applicant: Bayerische Motoren Werke Aktiengesellschaft, Muenchen (DE)

(72) Inventors: Liang CHEN, Muenchen (DE); Tomas Urban, Holzkirchen (DE); Thomas Wursthorn, Muenchen (DE)

(21) Appl. No.: 19/323,052

(22) Filed: Sep. 9, 2025

(30) Foreign Application Priority Data
Sep. 16, 2024 (DE) 10 2024 126 603.1

(51) Int. Cl. B60L 58/12; B60K 35/10; B60K 35/85; B60R 25/40

(52) U.S. Cl. CPC B60L 58/12; B60K 35/10; B60K 35/85; B60R 25/403; B60K 2360/566; B60K 2360/573; B60K 2360/5911; B60R 2325/103; B60R 2325/205

(57) ABSTRACT

A method for monitoring an energy storage device of a vehicle is disclosed, in which a state of charge of the energy storage device is monitored. A close-range communication connection is automatically established between the vehicle and a mobile device when a digital key stored on the mobile device is detected in a close range of the vehicle. Charging information relating to the state of charge is transmitted to the mobile device when the mobile device is connected via the close-range communication connection to the vehicle and a high energy consumption is detected while the vehicle is at a standstill and/or a low-power status of the energy storage device is reached.

### CROSS REFERENCE TO RELATED APPLICATION

This application claims priority under 35 U.S.C. § 119 from German Patent Application No. DE 10 2024 126 603.1, filed Sep. 16, 2024, the entire disclosure of which is herein expressly incorporated by reference.

### BACKGROUND AND SUMMARY

The invention relates to a method for monitoring an energy storage device. Furthermore, the invention relates to a vehicle assembly for carrying out the method.

Originally, vehicles were regularly unlocked and started using a “physical” key, which was inserted into a lock of the vehicle. Over time, digital keys were introduced, wherein the driver carries the digital key with them, for example, in the form of an NFC card or on a mobile telephone and the vehicle reads the digital key out of the physical carrier and unlocks the vehicle or starts it on request. Moreover, an energy storage device of the vehicle can be optimized based on the digital key.

Document CN 116 959 139 A discloses a method for battery optimization based on a digital key, in which battery data and vehicle data of a vehicle are captured and a statistical analysis is carried out according to the battery data and the vehicle data in order to obtain a result to assess the driving behavior. A corresponding driving guidance strategy is then proposed according to the result of the assessment of the driving behavior and transmitted to an associated execution unit of the vehicle. Furthermore, the digital key system receives the data of the battery and the vehicle, in this case not only the driving behavior can be evaluated, but also the battery can be monitored and maintained.

The invention is based on the object of creating a method of the type mentioned at the outset which is distinguished by improved monitoring of an energy storage device.

This object is achieved by a method and by a vehicle assembly having the features of the independent claims. Preferred or advantageous embodiments of the invention result from the dependent claims, the following description, and the appended figures.

According to the invention, a method for monitoring an energy storage device of a vehicle is provided, in which:
a state of charge of the energy storage device is monitored;
a wireless close-range communication connection is automatically established between the vehicle and a mobile device when a digital key stored on the mobile device is detected at close range to the vehicle;

charging information relating to the state of charge is transmitted to the mobile device when the digital key is connected via the close-range communication connection to the vehicle and a higher energy consumption is detected during a vehicle standstill and/or a low-power status of the energy storage device is reached.

The vehicle is preferably designed as a motor vehicle, in particular as a passenger vehicle, truck, bus, or the like. Alternatively, the vehicle can also be implemented as a two-wheeled vehicle, in particular a motorcycle, or a three-wheeled vehicle. The vehicle is particularly preferably designed as an electric vehicle, preferably as a battery-electric vehicle (BEV) or a plug-in hybrid (PHEV).

The energy storage device is used to store electrical energy. The energy storage device is preferably designed as a traction battery, which is designed and/or suitable in particular for providing electric energy for an electric drive unit, preferably an electric machine. The electric machine can be supplied with the electric energy from the energy storage device in drive operation in order to generate a drive torque. Optionally, the electric machine can charge the energy storage device in generator operation, for example, during recuperation.

The state of charge (SoC) indicates how much electric energy is stored in the energy storage device. The state of charge can be, for example, the charge amount, the stored energy amount, or an operative range resulting therefrom, for example, the range of the vehicle using the stored charge amount or energy amount. The state of charge is typically specified as a percentage of the maximum capacity. A state of charge of 100% means that the energy storage device is fully charged, while 0% means that it is completely discharged. The state of charge is preferably monitored in real time. A supervision unit is particularly preferably equipped so that it can determine the state of charge of the energy storage device.

The mobile device having the digital key can supervise at least one vehicle function via the close-range communication connection. For this purpose, supervision data, in particular commands, are transmitted to the vehicle via the close-range communication connection in order to activate the at least one vehicle function, for example, or supply it with parameters. The at least one vehicle function in particular comprises opening the vehicle and/or opening or closing a window and/or activating or deactivating a heating function and/or activating or deactivating the drive unit. The mobile device can in particular be a smart phone and/or a mobile telephone. Alternatively thereto, it can also be a tablet, phablet, notebook, or also a so-called wearable, such as a smartwatch, or a smart tag, etc.

The digital key preferably interacts with the vehicle via the close-range communication connection. The digital key is digitally generated and transmitted to the mobile device where it is used for identification and as proof of authorization during use of the vehicle. The digital key is preferably arranged and/or stored usably in a “mobile wallet”, also referred to as a digital wallet. The digital key is in particular designed as a certificate or comprises this certificate. In order to ensure the security and compatibility, the digital key could be designed according to the Car Connectivity Consortium (CCC) specifications release 3.0, which define the most recent standards for digital key technologies, including encryption and data transmission security.

The mobile device, without any initial input or request for an initial connection between the vehicle and the mobile device, due to the approach to the vehicle can establish the close-range communication connection with the vehicle or interact with the vehicle. In particular, the close-range communication connection is established between the vehicle and the mobile device upon approaching the vehicle and/or staying within the close range. The vehicle, in particular a communication module, can be designed to emit a communication signal repeatedly, in particular periodically, which indicates that the vehicle is ready to set up or establish the close-range communication connection. Furthermore, the mobile device can be designed to establish the close-range communication connection in reaction to receiving the communication signal. A close-range communication connection is preferably to be understood as a connection for contactless exchange of data which is restricted in its range, so that only mobile devices having the digital key in a predetermined area are recognized or connected. The range of the close-range communication device is restricted, for example, to at most 50 m, preferably at most 100 m.

The charging information includes in particular information about the state of charge of the energy storage device. In addition to the current state of charge, the charging information can also comprise further information with respect to a charging procedure and/or the energy storage device, however. For example, as the further information with respect to the charging procedure, the charging information can comprise a charging current and/or charging power and/or charging history and/or remaining charging time. Alternatively or optionally additionally, as further information with respect to the energy storage device, the charging information can comprise a voltage and/or temperature and/or a state of health (SoH) and/or warnings or errors states of the energy storage device.

To transmit the charging information to the mobile device, it has to be connected to the vehicle via the close-range communication connection and in addition a high energy consumption while the vehicle is at a standstill has to be detected. The current energy consumption and/or state of charge is preferably monitored, preferably by a monitoring module, wherein if a limiting value is exceeded, the charging information is transmitted to the mobile device. The charging information is particularly preferably transmitted when an elevated energy consumption is detected in the stopped and/or part state of the vehicle and/or when the digital key is arranged outside the vehicle.

Alternatively or optionally additionally, a low-power status of the energy storage device has to be reached to transmit the charging information to the mobile device. In particular, the available electrical energy of the energy storage device is strongly restricted in the low-power status. In the low-power status, the state of charge can have decreased enough that sufficient energy is no longer present to maintain specific functions or the normal operation of the vehicle. This can have the result that the vehicle changes into the energy saving mode or some non-critical systems are switched off. For example, the limiting value of the state of charge is below 20%, preferably below 15%, especially below 10% with respect to the fully-charged state (100% state of charge).

The invention is based on the finding that the user in the energy saving mode of the vehicle (low-power status) hardly recognizes the limits of the use of the digital key due to the lower energy budget for this function. Therefore, the user is possibly not aware that the vehicle will soon pass into a switching-off mode (power-off status), in which the function of the digital key is drastically restricted. In the energy saving mode, when the functionality of the digital key is still provided but is slightly reduced, the customer will not notice, for example, the smaller action radius of the digital key or the somewhat later triggering of the vehicle function, for example, unlocking of the vehicle. Except for the rather minor effects on the behavior of the digital key, the vehicle can pass into the switching-off mode, in which the user has to deal with strong restrictions for the daily use of the digital key, such as no triggering of the vehicle functions. The vehicle then has to be moved over longer distances or externally charged in order to reestablish the energy budget for the digital key.

The user can be informed early by the sending of the charging information in order to avoid a transition into the power-off status. The user can thus be informed or messaged in a timely manner, in particular upon detection of a high energy consumption and/or upon a transition into the low-power status, on the basis of the charging information so that the user can charge the energy storage device, for example, before the function of the digital key is restricted. An improved method for monitoring the energy storage device using a digital key is therefore proposed.

In a specific embodiment, it is provided that the current state of charge and/or an action recommendation is output on the mobile device based on the charging information. For example, the message and/or the action recommendation can be displayed in the form of a push message and/or animation on the mobile device. The user can then ensure on the basis of the message and/or action recommendation that the energy storage device is supplied with electrical energy.

In a specific embodiment, it is provided that a temporary deactivation of vehicle functions and/or a prompt to charge the energy storage device and/or a prompt to change the usage behavior of the vehicle, in particular the driving behavior, is output as an action recommendation. In particular, one or more action recommendations can be output depending on the state of charge. For example, first the prompt to change the usage behavior of the vehicle, then the prompt to charge the energy storage device, and finally the temporary deactivation of vehicle functions can be output. In principle, a proposal to deactivate one or more vehicle functions can be output as an action recommendation, so that the user can independently decide about their deactivation. Alternatively or optionally additionally, the vehicle functions can be deactivated independently by the vehicle, in particular from a defined limiting value. In particular, a duration for the deactivation of the vehicle functions can be proposed depending on the state of charge. For example, one or more vehicle functions can be deactivated for a defined duration, for example, more than 10 minutes or more than one hour and/or up to a defined point in time, for example, until the next morning. Preferably, vehicle functions having a high energy consumption, such as climate control system, heating, lighting, infotainment system, surroundings sensors, such as cameras, etc., are deactivated first.

In a further specific embodiment, the charging information is transmitted before a power-off status of the energy storage device is reached. In particular, a power-off status is to be understood as a status in which the energy storage device is completely switched off, so that electrical energy is no longer provided and all or at least most electrical systems of the vehicle are inactive. The power-off status preferably has the function of retaining the remaining charge of the energy storage device. Safety and monitoring systems, such as door locks or alarm systems, preferably remain active in the power-off status. For example, a limiting value of the state of charge in the power-out status is below 5% in relation to the fully charged state (100% state of charge). The customer can therefore be informed early and then charge the vehicle before the power-off status occurs.

In one refinement, it is proposed that the charging information is transmitted when the vehicle is or has been parked. In other words, the charging information is only transmitted when the user ends the journey and/or leaves the vehicle in order to be able to charge the vehicle using an external charging device. Alternatively or optionally additionally, the charging information is transmitted when multiple successive short routes have been covered by the vehicle. In other words, the user is only informed when the successive journeys, in particular in a hybrid vehicle, are too short to keep the voltage of the energy storage device sufficiently high to ensure the full functionality of the digital key. For example, a change of the driving behavior, for example, driving a long route, can be output as an action recommendation. The transmission of the charging information can therefore be bound to the behavior of the user. In particular, the user being overwhelmed with messages is thus prevented.

In a further embodiment, it is provided that the charging information is transmitted via the close-range communication connection to the mobile device. In particular, the close-range communication connection is used as a direct, preferably secured communication channel (“pass-through channel”) between the vehicle and the mobile device, thus without further instances interconnected. The charging information can therefore be transmitted directly to the mobile device. Alternatively or optionally additionally, the charging information is transmitted via a long-range communication connection to the mobile device. For example, a long-range communication connection can be understood as a 3G, 4G, or 5G network. The mobile device can in this case be coupled directly with the vehicle via the long-range communication connection or can be coupled indirectly via a server instance with the vehicle. The server instance can be implemented as an individual server, a plurality of servers, or as a cloud.

In a further specific embodiment, it is provided that the charging information, in particular the current state of charge and/or the action recommendation, is displayed on the mobile device via an app installed on the mobile device, such as the “My BMW App”. The app is preferably designed to receive the digital key, locate the vehicle, and communicate with the driver. For example, the state of charge and/or the action recommendation can be displayed within the app.

In a further specific embodiment, it is provided that the close-range communication connection is formed by a BLE and/or UWB connection. In other words, the communication connection is established wirelessly on the basis of BLE and/or UWB. Bluetooth Low Energy (BLE) is an energy-efficient form of the Bluetooth standard which is conceived especially for short ranges and applications in which a low energy consumption is important. Ultra-wideband (UWB) is a radio technology which uses extremely wideband signals for communication and precise localization. UWB is known for its capability of carrying out accurate distance and position measurements, even in environments having many obstacles and a large amount of interference. The enhanced localization accuracy due to the combination of UWB and/or BLE results in improved localization of the key position, so that the transmission of the charging information can first take place when the user approaches and/or moves away from the vehicle up to a defined distance.

A further subject matter of the invention relates to a vehicle assembly which is oriented and/or suitable for carrying out the above-described method. The vehicle assembly comprises the mobile device, wherein the digital key is arranged on the mobile device. Furthermore, the vehicle assembly comprises the vehicle, wherein the vehicle comprises the energy storage device for storing electric energy, a monitoring module for monitoring the state of charge of the energy storage device, and a communication module for establishing a close-range communication connection to the mobile device.

The communication module and/or the monitoring module can be designed as a hardware or software module, in particular of the supervision unit. The mobile device and the communication module are preferably configured for communication with one another. The communication module is preferably designed to establish and/or maintain the close range and optionally the long-range communication. The communication module enables the exchange of information between the vehicle and the mobile device in order to control various vehicle functions, monitor data, or transmit information, in particular the charging information. The monitoring module is preferably designed to continuously monitor the state of charge of the electrical energy storage device. The module captures and analyzes relevant parameters of the energy storage device, such as the current charge capacity, the voltage, the current flow, the temperature, and other data relevant for the state of charge, and assesses them in real time in order to determine and forward the current state of charge of the energy storage device. The communication module is designed to transmit the charging information to the mobile device when the close-range communication connection is established between vehicle and mobile device or the digital key is connected to the vehicle and at the same time a high energy consumption is detected while the vehicle is at a standstill and/or a low-power status of the energy storage device is detected by the monitoring module.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a very schematic representation of a vehicle assembly as an exemplary embodiment of the invention.

Parts corresponding to one another or identical parts are each provided with identical reference signs in the figure.

### DETAILED DESCRIPTION OF THE DRAWING

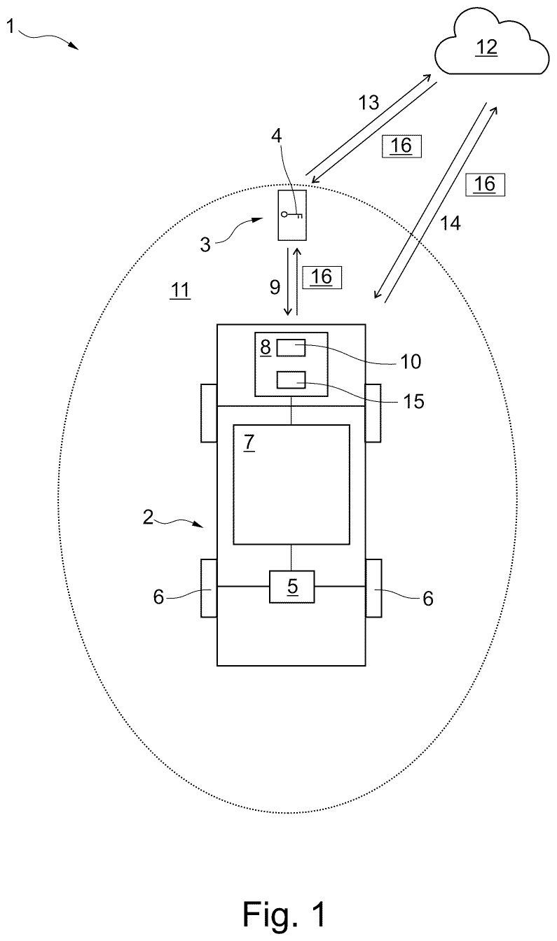

FIG. 1 shows a schematic block diagram of a vehicle assembly 1 as an exemplary embodiment of the invention and to represent an exemplary embodiment of the method.

The vehicle assembly 1 comprises a vehicle 2 and a mobile device 3, which can be carried by a user. For example, the mobile device 3 is designed as a smart phone. The mobile device 3 comprises a digital key 4 and is thus assigned to the user. The digital key 4 is stored, for example, in a protected storage area, in particular on a secure element or a wallet, on the mobile device 3. Rights or authorizations to use functions of the vehicle 2 can be stored on the digital key 4. The functions can thus comprise, for example, starting, opening, etc. the vehicle 2.

The vehicle 2 is designed as an electric vehicle, preferably a battery-electric vehicle (BEV) or hybrid vehicle (PHEV). The vehicle 2 comprises an electric drive unit 5 for this purpose, which is designed to generate a traction torque and is connected with respect to drive to at least two vehicle wheels 6. Furthermore, the vehicle 2 comprises an energy storage device 7, which is configured to store and provide electric energy for the drive unit 5, preferably an electric machine.

The vehicle 2 comprises a supervision unit 8, which comprises a vehicle service environment. The supervision unit 8 is preferably designed as a digital data processing unit. The vehicle service environment can be designed, for example, as an operating system having apps. A key system designed according to CCC specifications is implemented so it is executable on the mobile device 3 and the supervision unit 8.

The digital key 4 can establish a secured close-range communication connection 9 with the vehicle service structure of the supervision unit 8. The supervision unit 8 comprises at least one communication module 10 for this purpose, which is configured to establish the close-range communication connection 9 between vehicle 2 and the terminal 3. The secured close-range communication connection 9 is authorized in this case via the digital key 4 and takes place in particular according to the CCC specifications. A distance and/or a relative position between the mobile device 3 and the vehicle 2 can be determined and/or data can be exchanged between the mobile device 3 and the vehicle 2 via the close-range communication connection 9. For example, the close-range communication connection 9 can be automatically established between the mobile device 3 and the vehicle 2 as soon as a distance between the mobile device 3 and the vehicle 2 is less than or equal to a distance threshold value of a close range 11 of the vehicle 2. For example, the threshold value can be less than 100 m, preferably less than 50 m. The close-range communication connection 9 can be designed as a UWB and/or BLE communication connection.

The supervision unit 5 is designed to control at least one vehicle function of the vehicle 2 depending on the communication between the mobile device 3 and the vehicle 2. For example, a control command for controlling one or more vehicle functions, such as unlocking a door and/or opening or closing a window and/or activating or deactivating a heating function and/or activating or deactivating the drive unit 8 of the vehicle 2, can be triggered via the close-range communication connection 9. The digital key 4 can be verified, in particular authenticated, in this context. Furthermore, after successful authentication, one or more vehicle functions can be controlled, in particular depending on the distance between the mobile device 3 and the vehicle 2; the location of the mobile device 3 relative to the vehicle 2, and/or supervision data, which are sent from the mobile device 3 via the close-range communication connection 9 to the vehicle 2.

The vehicle assembly 1 moreover comprises a server instance 12, wherein the server instance 12 is designed as a cloud and can comprise one or more servers or other computers. For example, the digital key 4 for the vehicle 3 is held in the server instance 12. Optionally, the digital key 4 is generated in the server instance 12. For this purpose, the mobile device 3 uses, for example, key information, which in the simplest case is designed as a link, in particular a download link, to request the digital key 4. After the digital key 4 is downloaded, it can be installed on the user device 3, for example, in a mobile wallet.

The server instance 12 can communicate via one long-range communication connection 13 with the mobile device 3 and via a further long-range communication connection 14 with the vehicle 2. The long-range communication connections 13, 14 are designed as a secured and/or secure, for example, encrypted communication connection. For example, it can be provided that the server instance 12 and the vehicle 2 or the mobile device 3 exchange certificates for mutual authentication so that a mutual check is provided. The mobile device 4 can be designed to request the digital key 2 via the long-range communication connection 13 and accept it from the server instance 12. The communication module 10 can optionally transmit a data set to the server instance 12. The mobile device 3 linked with the vehicle 2 can be determined there and the data set—possibly correspondingly processed—can be transmitted from the server instance 12 to the mobile device 3.

For this purpose, the vehicle 2 and the digital key 3 continuously have to be in a standby mode in order to be able to react to signals, by which electric energy of the energy storage device 7 is consumed. Moreover, the encrypted communication and the vehicle functions also require electric energy from the energy storage device 7. To detect the energy consumption of the energy storage device 7, the supervision unit 8 comprises a monitoring module 15, which monitors a state of charge of the energy storage device 7 in real time.

The communication module 10 is designed here to transmit charging information 16 relating to the state of charge to the mobile device 3 when the digital key 4 is detected at close range 11 or is connected via the close-range communication connection 9 and when at the same time a high energy consumption is detected when the vehicle 2 is at a standstill and/or a low-power status of the energy storage device 7 is reached. Formulated in simplified terms, the user receives feedback via their mobile device 3 having the digital key when a high energy consumption occurs while the mobile device 3 is connected to the vehicle 2. For example, the charging information 16 is transmitted to the mobile device 3 before a power-off status of the energy storage device 7 is reached. The charging information 16 can be transmitted in this case directly via the close-range communication connection 9 to the mobile device 9 and/or via the long-range communication connections 13, 14 indirectly via the server instance 12 to the mobile device 4. For example, the charging information 16 can be processed or prepared by the server instance before it is transmitted to the mobile device 3.

Furthermore, based on the charging information 16, the current state of charge and/or an action recommendation can be output or displayed on the mobile device 4, preferably in an app installed on the mobile device 3. For example, a warning message can be output when the energy storage device 7 reaches the low-power status and/or a limiting value with respect to the energy consumption is exceeded. Furthermore, a temporary deactivation of one or more vehicle functions for a specific period of time, for example, for one hour, or up to a specific point in time, for example, until the next morning, can be proposed and/or triggered as an action recommendation. Alternatively or optionally additionally, a prompt to charge the energy storage device and/or a prompt to change the usage behavior of the vehicle can be displayed or output on the mobile device 4 as an action recommendation.

In order not to overwhelm the user with messages, the charging information 16 is preferably transmitted to the mobile device 3 after the journey or when the vehicle is at a standstill. For example, the charging information 16 is transmitted when the vehicle 2 has been parked and/or multiple successive short routes have been covered by the vehicle 2, so that the user can charge the energy storage device 7 via a charging station or can reduce the energy consumption by changing their usage behavior.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Signs

1 vehicle assembly
2 vehicle
3 mobile device
4 digital key
5 drive unit
6 vehicle wheels
7 energy storage device
8 supervision unit
9 close-range communication connection
10 communication module
11 close range
12 server instance
13 long-range communication connection
14 further long-range communication connection
15 monitoring module
16 charging information

What is claimed is:

1. A method for monitoring an energy storage device of a vehicle, comprising:
monitoring a state of charge of the energy storage device;
automatically establishing a close-range communication connection between the vehicle and a mobile device when a digital key stored on the mobile device is detected in a close range of the vehicle; and
transmitting charging information relating to the state of charge to the mobile device when the mobile device is connected to the vehicle via the close-range communication connection and a high energy consumption is detected while the vehicle is at a standstill and/or a low-power status of the energy storage device is reached.

2. The method according to claim 1, wherein
a current state of charge and/or an action recommendation is displayed on the mobile device based on the charging information.

3. The method according to claim 2, wherein a temporary deactivation of vehicle functions and/or a prompt to charge the energy storage device and/or a prompt to change usage behavior of the vehicle is output as an action recommendation.

4. The method according to claim 1, wherein the charging information is transmitted before a power-off status of the energy storage device is reached.

5. The method according to claim 1, wherein the charging information is transmitted when the vehicle is parked.

6. The method according to claim 1, wherein the charging information is transmitted when multiple successive short routes have been covered by the vehicle.

7. The method according to claim 1, wherein the charging information is transmitted to the mobile device via the close-range communication connection and/or via a long-range communication connection.

8. The method according to claim 1, wherein the charging information is displayed via an app installed on the mobile device.

9. The method according to claim 1, wherein the close-range communication connection is formed by a BLE and/or UWB connection.

10. A vehicle system, comprising:
a mobile device, wherein a digital key is arranged on the mobile device,
a vehicle comprising an energy storage device for storing electric energy, a monitoring module for monitoring a state of charge of the energy storage device, and a communication module for establishing a close-range communication connection to the mobile device,
wherein the communication module is configured to:
transmit charging information to the mobile device when the mobile device is connected via the close-range communication connection to the vehicle and a high energy consumption is detected by the monitoring module while the vehicle is at a standstill and/or a low-power status of the energy storage device is detected by the monitoring module.
